(19) United States
(12) Patent Application Publication
(10) Pub. No.: US 2025/0254731 A1
(43) Pub. Date: Aug. 7, 2025

(54) METHOD AND APPARATUS FOR PREAMBLE CONFIGURATION IN A WIRELESS COMMUNICATION SYSTEM

(71) Applicant: ASUS Technology Licensing Inc., Taipei City (TW)

(72) Inventor: Ko-Chiang Lin, Taipei City (TW)

(21) Appl. No.: 19/036,889

(22) Filed: Jan. 24, 2025

Related U.S. Application Data
(60) Provisional application No. 63/627,931, filed on Feb. 1, 2024.

(51) Int. Cl. H04W 74/0833; H04W 76/10; H04W 76/20; H04W 76/30

(52) U.S. Cl. CPC H04W 74/0833; H04W 76/10; H04W 76/20; H04W 76/30

(57) ABSTRACT

A method and device for a User Equipment (UE) are disclosed. In one embodiment, the UE receives a first Physical Random Access Channel (PRACH) configuration wherein the first PRACH configuration is indicated by a System Information Block (SIB) different from SIB1 wherein the SIB different from SIB1 is provided by a second cell. The UE also initiates a first random access procedure to request SIB1 on a first cell based on the first PRACH configuration.

### CROSS-REFERENCE TO RELATED APPLICATIONS

The present Application claims the benefit of U.S. Provisional Patent Application Ser. No. 63/627,931 filed on Feb. 1, 2024, the entire disclosure of which is incorporated herein in its entirety by reference.

### FIELD

This disclosure generally relates to wireless communication networks, and more particularly, to a method and apparatus for preamble configuration in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a User Equipment (UE) are disclosed. In one embodiment, the UE receives a first Physical Random Access Channel (PRACH) configuration wherein the first PRACH configuration is indicated by a System Information Block (SIB) different from SIB 1 wherein the SIB different from SIB1 is provided by a second cell. The UE also initiates a first random access procedure to request SIB1 on a first cell based on the first PRACH configuration.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.3.1-1 of 3GPP TS 38.211 V15.7.0.

FIG. 6 is a reproduction of Table 6.3.3.1-1 of 3GPP 38.211 V15.7.0.

FIG. 7 is a reproduction of Table 6.3.3.1-2 of 3GPP 38.211 V15.7.0.

FIG. 8 is a reproduction of Table 6.3.3.1-3 of 3GPP 38.211 V15.7.0.

FIG. 9 is a reproduction of Table 6.3.3.1-4 of 3GPP 38.211 V15.7.0.

FIG. 10 is a reproduction of Table 6.3.3.1-5 of 3GPP 38.211 V15.7.0.

FIG. 11 is a reproduction of Table 6.3.3.2-1 of 3GPP 38.211 V15.7.0.

FIG. 12 is a reproduction of Table 6.3.3.2-2 of 3GPP 38.211 V15.7.0.

FIG. 13 is a flow chart according to one exemplary embodiment.

FIG. 14 is a flow chart according to one exemplary embodiment.

FIG. 15 is a flow chart according to one exemplary embodiment.

FIG. 15 is a flow chart according to one exemplary embodiment.

FIG. 16 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.211 V15.7.0, “NR; Physical channels and modulation (Release 15)”; TS 38.213 V18.0.0, “NR; Physical layer procedures for control (Release 18)”; TS 38.321 V17.6.0, “NR; Medium Access (MAC) protocol specification (Release 17)”; TS 38.331 V17.6.0, “NR; Radio Resource Control (RRC) protocol specification (Release 17)”; and RP-234065, “New WID: Enhancements of network energy savings for NR”, Ericsson. The standards and documents listed above are hereby expressly incorporated by reference in their entirety.

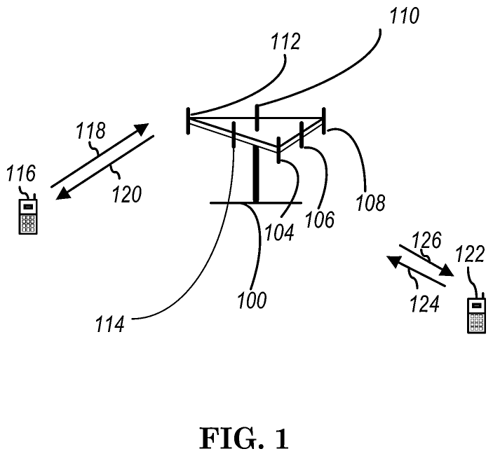

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

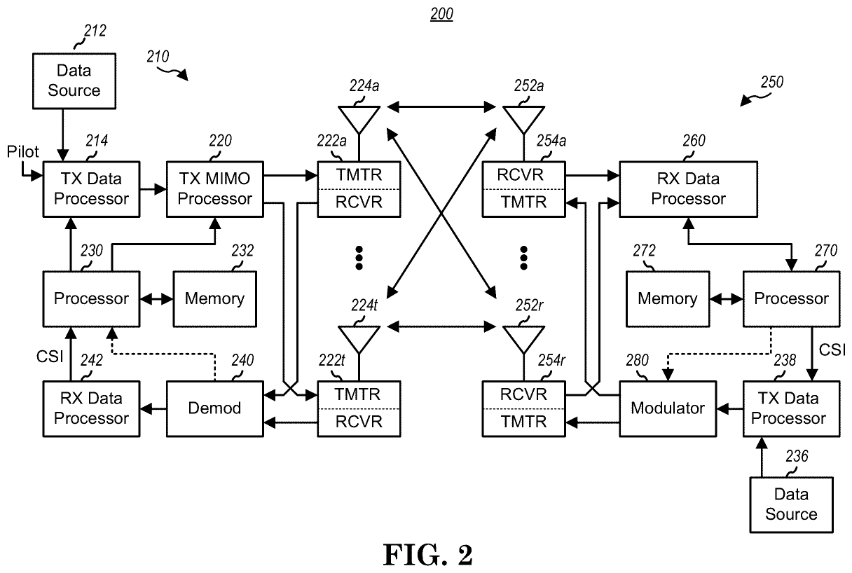

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

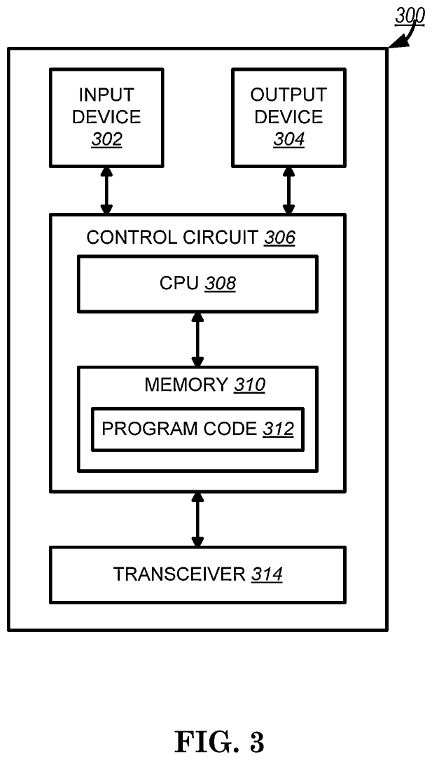

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

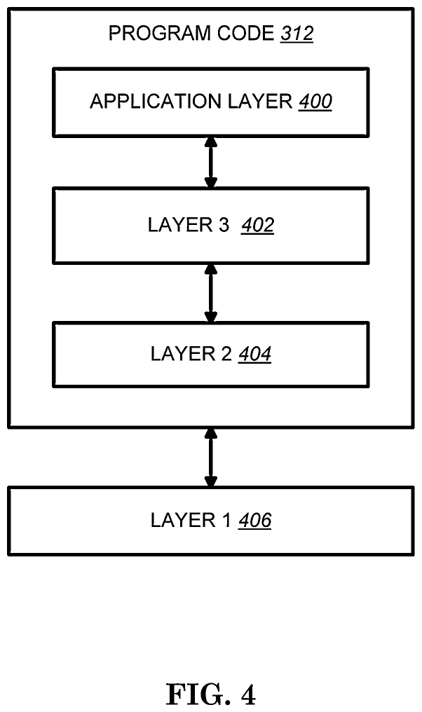

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Frame structure used in New RAT (NR) for 5G, to accommodate various type of requirement (as discussed in 3GPP TS 38.211 V15.7.0) for time and frequency resource, e.g. from ultra-low latency (˜0.5 ms) to delay-tolerant traffic for Machine-Type Communication (MTC), from high peak rate for eMBB to very low data rate for MTC. An important focus of this study is low latency aspect, e.g. short Transmission Time Interval (TTI), while other aspect of mixing/adapting different TTIs can also be considered in the study. In addition to diverse services and requirements, forward compatibility is an important consideration in initial NR frame structure design as not all features of NR would be included in the beginning phase/release.

More details of NR frame structure, channel and numerology design are discussed and provided below in 3GPP TS 38.211:

### 4.3 Frame Structure

### 4.3.1 Frames and Subframes

Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is N_{symb}^{subfame,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier. Uplink frame number i for transmission from the UE shall start T_{TA}=(N_{TA}+N_{TAoffset})T_{c} before the start of the corresponding downlink frame at the UE where N_{TAoffset} is given by [5, TS 38.213].

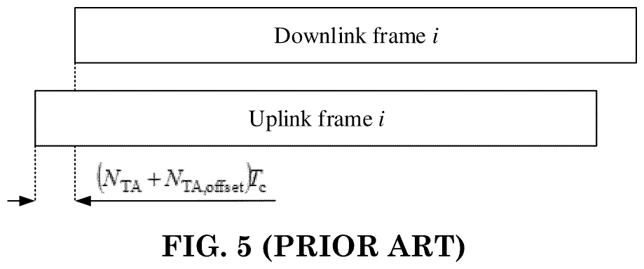

### [FIG. 4.3.1-1 of 3GPP TS 38.211 V15.7.0, Entitled “Uplink-Downlink Timing Relation”, is Reproduced as FIG. 5]

### 4.3.2 Slots

For subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by Tables 4.3.2-1 and 4.3.2-2. The start of slot nₛ^{μ} in a subframe is aligned in time with the start of OFDM symbol nₛ^{μ}N_{symb}^{slot} in the same subframe.

OFDM symbols in a slot can be classified as ‘downlink’, ‘flexible’, or ‘uplink’. Signaling of slot formats is described in subclause 11.1 of [5, TS 38.213].

In a slot in a downlink frame, the UE shall assume that downlink transmissions only occur in ‘downlink’ or ‘flexible’ symbols.

In a slot in an uplink frame, the UE shall only transmit in ‘uplink’ or ‘flexible’ symbols.

### 4.4.5 Bandwidth Part

A bandwidth part is a subset of contiguous common resource blocks defined in subclause 4.4.4.3 for a given numerology u; in bandwidth part i on a given carrier. The starting position N_{BWP,i}^{start,μ} and the number of resource blocks N_{BWP,i}^{size,μ} in a bandwidth part shall fulfil N_{grip,x}^{start,μ}≤N_{BWP,i}^{start,μ}<N_{grip,x}^{start,μ}+N_{grip,x}^{size,μ} and N_{grid,x}^{start,μ}<N_{BWP,i}^{start,μ}+N_{BWP,i}^{size,μ}≤N_{grid,x}^{start,μ}+N_{grid,x}^{size,μ}, respectively. Configuration of a bandwidth part is described in clause 12 of [5, TS 38.213].

A UE can be configured with up to four bandwidth parts in the downlink with a single downlink bandwidth part being active at a given time. The UE is not expected to receive PDSCH, PDCCH, or CSI-RS (except for RRM) outside an active bandwidth part.

A UE can be configured with up to four bandwidth parts in the uplink with a single uplink bandwidth part being active at a given time. If a UE is configured with a supplementary uplink, the UE can in addition be configured with up to four bandwidth parts in the supplementary uplink with a single supplementary uplink bandwidth part being active at a given time. The UE shall not transmit PUSCH or PUCCH outside an active bandwidth part. For an active cell, the UE shall not transmit SRS outside an active bandwidth part.

Unless otherwise noted, the description in this specification applies to each of the bandwidth parts. When there is no risk of confusion, the index u may be dropped from N_{BWP,i}^{start,μ}, N_{BWP,i}^{size,μ}, N_{grid,x}^{start,μ}, and N_{grid,x}^{size,μ}.

### 4.5 Carrier Aggregation

Transmissions in multiple cells can be aggregated. Unless otherwise noted, the description in this specification applies to each of the serving cells.

Random access procedure is introduced for several purposes, e.g. to acquire UL (Uplink) synchronization (e.g. UL TA (Timing Advance)), to ask for UL grants resource(s), to recover form beam failure and so on. Random access procedure could be categorized into contention based random access procedure and non-contention based random access procedure. For non-contention based random access procedure, a dedicated preamble (as well as dedicated Physical Random Access Channel (PRACH) resource) is assigned to the UE so that gNB could identify the UE transmitting the preamble via preamble detection/reception. For requesting system information, a dedicated preamble could be allocated for requesting a (specific) SI/SIB(s) (e.g. SIB2). The dedicated preamble could be utilized by all UEs requesting the SI/SIB(s). (e.g. for requesting system information, identifying the UE is not necessary). The UE would then monitor random access response from the base station. The non-contention based random access random access procedure would be considered as complete successfully when/if the random access response to the transmitted preamble is received. On the other hand, for contention-based random access procedure, a preamble is randomly selected from a set of available preambles (e.g. which may depends on a purpose or situation or UE which initiates the random access procedure). After transmitting the random access preamble, the UE could monitor the corresponding random access response. After successfully receiving the random access response, the UE would transmit a Msg 3 (which could be used to identified the UE). After transmitting Msg3, the UE would monitor a contention resolution (e.g. Msg 4). If contention resolution for the UE is successfully received, the UE would consider the random access procedure is successfully finished. More details related to random access procedure are discussed and provided below in 3GPP TS 38.213, TS 38.211, TS 38.321, and TS 38.331.

In particular, 3GPP TS 38.213 states:

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A. Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

### 8.1 Random Access Preamble

Physical random access procedure for a UE is triggered upon request of a PRACH transmission by higher layers or by a PDCCH order for a cell. A configuration by higher layers for a PRACH transmission includes the following:
A configuration for PRACH transmission on the cell [4, TS 38.211].
A preamble index, a preamble SCS, P_{PRACH,target}, a corresponding RA-RNTI when applicable [11, TS 38.321], and a PRACH resource for the cell.
A number of N_{preamble}^{rep}>1 preamble repetitions for the PRACH transmission if the UE would transmit the PRACH with repetitions.

A UE transmits a PRACH on a cell using the selected PRACH format with transmission power P_{PRACH,b,f,c}(i), as described in clause 7.4, on the indicated PRACH resource or on determined N_{preamble}^{rep} resources in case of N_{preamble}^{rep} preamble repetitions.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For a random access procedure associated with a feature combination indicated by FeatureCombinationPreambles, a UE is provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and numberOfPreamblesPerSSB-ForThisPartition. The PRACH transmission can be on a subset of PRACH occasions associated with a same SS/PBCH block index within an SSB-RO mapping cycle for a UE provided with a PRACH mask index by ssb-SharedRO-MaskIndex according to [11, TS 38.321].

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

For link recovery, a UE is provided N SS/PBCH block indexes associated with one PRACH occasion by ssb-perRACH-Occasion in BeamFailureRecoveryConfig. For a dedicated RACH configuration provided by RACH-ConfigDedicated, if cfra is provided, a UE is provided N SS/PBCH block indexes associated with one PRACH occasion by ssb-perRACH-Occasion in occasions. If N<1, one SS/PBCH block index is mapped to 1/N consecutive valid PRACH occasions. If N≥1, all consecutive N SS/PBCH block indexes are associated with one PRACH occasion.

For a PRACH transmission by a UE triggered by a PDCCH order, the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order and, if any, a cell indicator field indicates a cell for the PRACH transmission [5, TS 38.212]. If the UE is provided K_{cell,offset} by cellSpecifickoffset, the PRACH occasion is after slot n+2^{μ}·K_{cell,offset} where n is the slot of the UL BWP for the PRACH transmission that overlaps with the end of the PDCCH order reception assuming T_{TA}=0, and μ is the SCS configuration for the PRACH transmission. If the PDCCH reception for the PDCCH order includes two PDCCH candidates from two linked search space sets based on searchSpaceLinkingld, as described in clause 10.1, the last symbol of the PDCCH reception is the last symbol of the PDCCH candidate that ends later. The PDCCH reception includes the two PDCCH candidates also when the UE is not required to monitor one of the two PDCCH candidates as described in clauses 10 (except clause 10.4), 11.1, 11.1.1 and 17.2.

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For a PRACH transmission with N_{preamble}^{rep} preamble repetitions, all respective valid PRACH occasions are consecutive in time, use same frequency resources, and are associated with a same SS/PBCH block index.

For a PRACH transmission with N_{preamble}^{rep} preamble repetitions, a time period, starting from frame 0, is the smallest integer number of SS/PBCH block to PRACH occasion association pattern periods such that N_{Tx}^{SSB} SS/PBCH block indexes are mapped at least once to N_{preamble}^{rep} PRACH occasions within the time period for each configured N_{preamble}^{rep} number of preamble repetitions. The set of N_{preamble}^{rep} PRACH occasions for a PRACH transmission repeats every time period.

For a PRACH transmission with N_{preamble}^{rep} preamble repetitions within a time period for N_{preamble}^{rep} preamble repetitions associated with an SS/PBCH block Nrep
if TimeOffsetBetweenStartingRO is provided, for each frequency resource index for frequency multiplexed PRACH occasions,
   the first valid PRACH occasion of the first N_{preamble}^{rep} preamble repetitions is the first valid PRACH occasion
   the first valid PRACH occasion of subsequent N_{preamble}^{rep} preamble repetitions is after TimeOffsetBetweenStartingRO consecutive valid PRACH occasions in time from the first valid PRACH occasion corresponding to the previous N_{preamble}^{rep} preamble repetitions
otherwise,
   the first valid PRACH occasion of the first N_{preamble}^{rep} preamble repetitions is the first valid PRACH occasion
   the first valid PRACH occasion of subsequent N_{preamble}^{rep} preamble repetitions, if any, is determined after the ROs determined for the previous N_{preamble}^{rep} preamble repetitions according to an ordering of valid PRACH occasions
      first, in increasing order of frequency resource indexes for frequency multiplexed PRACH occasions
      second, in increasing order of time resource indexes for time multiplexed PRACH occasions

For a PRACH transmission triggered upon request by higher layers, a value of ra-OccasionList [12, TS 38.331], if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

### 8.2 Random Access Response-Type-1 Random Access Procedure

In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the last PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [4, TS 38.211], is not zero, the window starts after an additional T_{TA}+K_{mac} msec where T_{TA} is defined in [4, TS 38.211] and k_{mac} is provided by kmac or k_{mac}=0 if kmac is not provided. The length of the window in number of slots, based on the SCS for Type1-PDCCH CSS set, is provided by ra-ResponseWindow.

Also, 3GPP TS 38.211 states:

### 6.3.3 Physical Random-Access Channel

### 6.3.3.1 Sequence Generation

The set of random-access preambles x_{u,v}(n) shall be generated according to

$${x}_{u , v} ( n ) = {x}_{u} ( ( n + {C}_{v} ) mod {L}_{RA} )$$

$${x}_{u} ( i ) = {e}^{- j \frac{π ui ( i + 1 )}{{L}_{RA}}} , i = 0 , 1 , … , {L}_{RA} - 1$$

from which the frequency-domain representation shall be generated according to

$${y}_{u , v} ( n ) = {\sum }_{m = 0}^{{L}_{RA} - 1} {x}_{u , v} ( m ) \cdot {e}^{- j \frac{2 π mn}{{L}_{RA}}}$$

where L_{RA}=839 or L_{RA}=139 depending on the PRACH preamble format as given by Tables 6.3.3.1-1 and 6.3.3.1-2.

There are 64 preambles defined in each time-frequency PRACH occasion, enumerated in increasing order of first increasing cyclic shift Cᵥ of a logical root sequence, and then in increasing order of the logical root sequence index, starting with the index obtained from the higher-layer parameter prach-RootSequenceIndex or rootSequenceIndex-BFR. Additional preamble sequences, in case 64 preambles cannot be generated from a single root Zadoff-Chu sequence, are obtained from the root sequences with the consecutive logical indexes until all the 64 sequences are found. The logical root sequence order is cyclic; the logical index 0 is consecutive to 837 when L_{RA}=839 and is consecutive to 137 when L_{RA}=139 The sequence number u is obtained from the logical root sequence index according to Tables 6.3.3.1-3 and 6.3.3.1-4.

The cyclic shift Cᵥ is given by

$${C}_{v} = \{ \begin{matrix}{vN}_{CS} & v = 0 , 1 , … , ⌊ {L}_{RA} / {N}_{CS} ⌋ - 1 , {N}_{CS} \neq 0 & for unrestricted sets \\ 0 & {N}_{CS} = 0 & for unrestricted sets \\ {\underline{\underline{d}}}_{start} ⌊ v / {n}_{shift}^{RA} ⌋ + ( v mod {n}_{shift}^{RA} ) {N}_{CS} & v = 0 , 1 , … , w - 1 & for restricted sets type A and B \\ {\underline{\underline{\underline{d}}}}_{start} + ( v - w ) {N}_{CS} & v = w , … , w + {\overline{\overline{n}}}_{shift}^{RA} - 1 & for restricted sets type B \\ {d}_{start} + ( v - w - {\overline{\overline{n}}}_{shift}^{RA} ) {N}_{CS} & v = w + {\overline{\overline{n}}}_{shift}^{RA} , … , w + {\overline{\overline{n}}}_{shift}^{RA} + {\overline{\overline{\overline{n}}}}_{shift}^{RA} - 1 & for restricted sets type B\end{matrix}$$

$$w = {n}_{shift}^{RA} {n}_{group}^{RA} + {\overline{n}}_{shift}^{RA}$$

where N_{CS} is given by Tables 6.3.3.1-5 to 6.3.3.1-7, the higher-layer parameter restrictedSetConfig determines the type of restricted sets (unrestricted, restricted type A, restricted type B), and Tables 6.3.3.1-1 and 6.3.3.1-2 indicate the type of restricted sets supported for the different preamble formats.

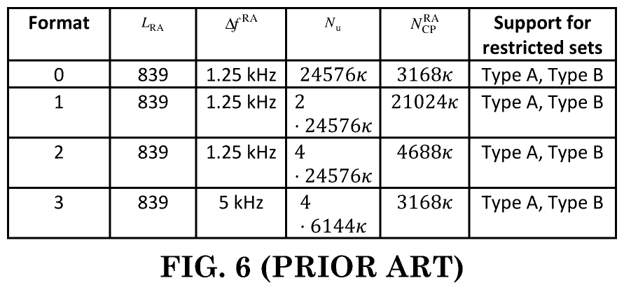

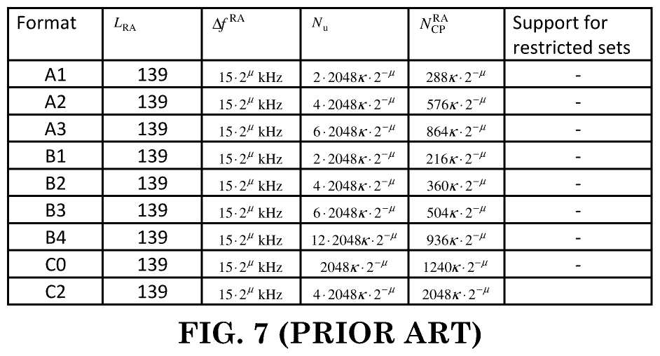

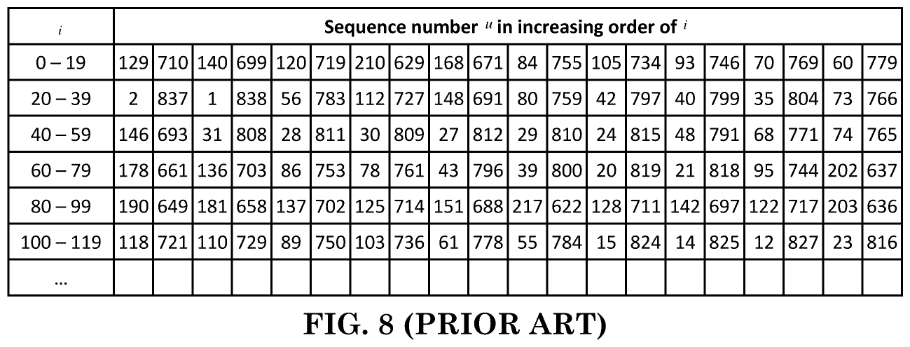

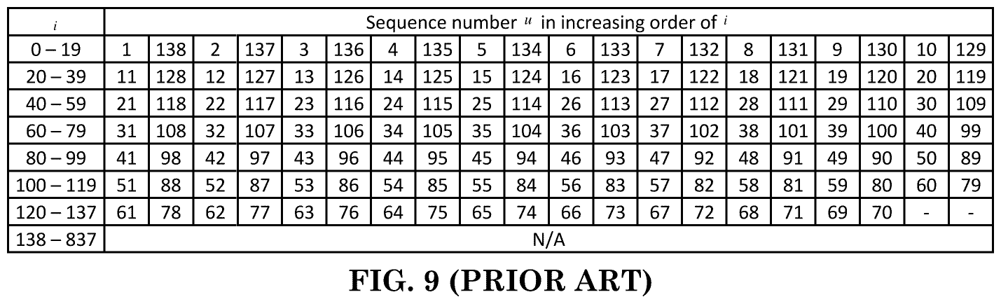

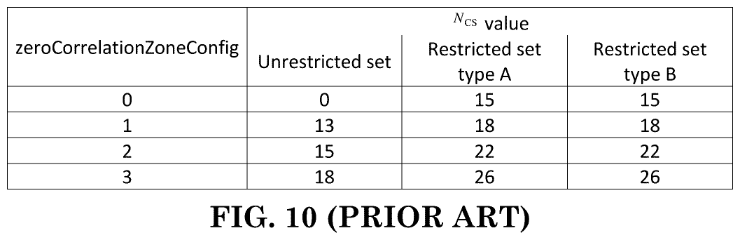

The variable dᵤ is given by

$${d}_{u} = \{ \begin{matrix}q & 0 \leq q < {L}_{RA} / 2 \\ {L}_{RA} - q & otherwise\end{matrix}$$

where q is the smallest non-negative integer that fulfils (qu)mod L_{RA}=1 The parameters for restricted sets of cyclic shifts depend on dᵤ.
[Table 6.3.3.1-1 of 3GPP 38.211 V15.7.0, Entitled “PRACH Preamble Formats for L_{RA}=839 and Δf^{RA}∈{1.25, 5} kHz”, is Reproduced as FIG. 6]
[Table 6.3.3.1-2 of 3GPP 38.211 V15.7.0, Entitled “Preamble Formats for L_{RA}=139 and Δf^{RA}=15·2^{μ} kHz where μ∈{0,1,2,3}”, is Reproduced as FIG. 7]
[Table 6.3.3.1-3 of 3GPP 38.211 V15.7.0, Entitled “Mapping from Logical Index i to Sequence Number u for Preamble Formats with L_{RA}=839n, is Reproduced as FIG. 8]
[Table 6.3.3.1-4 of 3GPP 38.211 V15.7.0, Entitled “Mapping from Logical Index i to Sequence Number” for Preamble Formats with L_{RA}=139”, is Reproduced as FIG. 9]
[Table 6.3.3.1-5 of 3GPP 38.211 V15.7.0, Entitled “N_{CS} for Preamble Formats with Δf^{RA}=1.25 kHz”, is Reproduced as FIG. 10]

### 6.3.3.2 Mapping to Physical Resources

Random access preambles can only be transmitted in the time resources given by the higher-layer parameter prach-ConfigurationIndex according to Tables 6.3.3.2-2 to 6.3.3.2-4 and depends on FR1 or FR2 and the spectrum type as defined in [8, TS38.104].

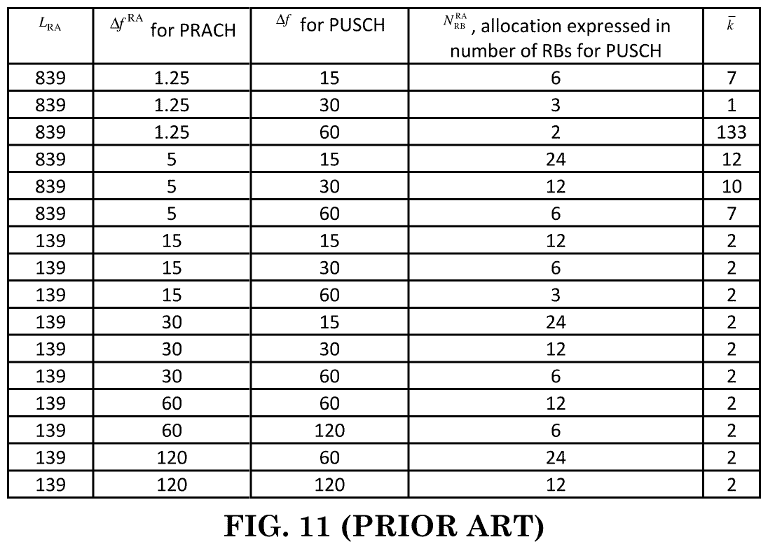

Random access preambles can only be transmitted in the frequency resources given by the higher-layer parameter msg1-FrequencyStart. The PRACH frequency resources n_{RA}∈{0,1, . . . , M−1}, where M equals the higher-layer parameter msg1-FDM, are numbered in increasing order within the initial uplink bandwidth part during initial access, starting from the lowest frequency. Otherwise, NRA are numbered in increasing order within the active uplink bandwidth part, starting from the lowest frequency.

[Table 6.3.3.2-1 of 3GPP 38.211 V15.7.0, Entitled “Supported Combinations of Δf^{RA} and Δf, and the Corresponding Value of k̅”, is Reproduced as FIG. 11]

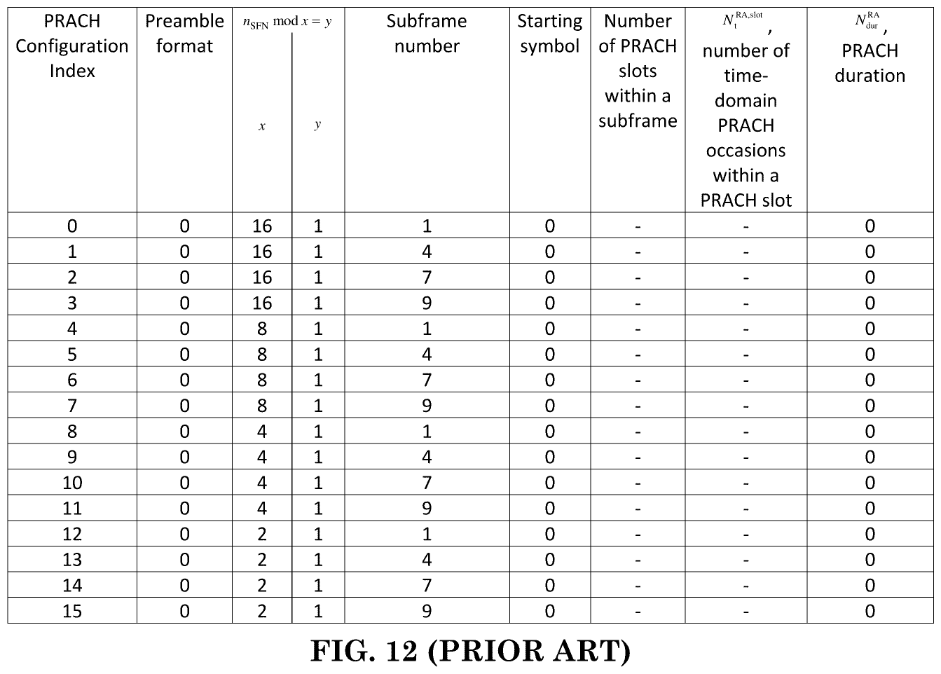

### [Table 6.3.3.2-2 of 3GPP 38.211 V15.7.0, Entitled “Random Access Configurations for FR1 and Paired Spectrum/Supplementary Uplink”, is Reproduced as FIG. 12]

Furthermore, 3GPP TS 38.321 states:

### 5.1.2 Random Access Resource Selection

If the selected RA_TYPE is set to 4-stepRA, the MAC entity shall:
1> if the Random Access procedure was initiated for SpCell beam failure recovery (as specified in clause 5.17); and
1> if the beamFailureRecoveryTimer (in clause 5.17) is either running or not configured; and
1> if the contention-free Random Access Resources for beam failure recovery request associated with any of the SSBs and/or CSI-RSs have been explicitly provided by RRC; and
1> if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2> select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2> if CSI-RS is selected, and there is no ra-PreambleIndex associated with the selected CSI-RS:
      3> set the PREAMBLE_INDEX to a ra-PreambleIndex corresponding to the SSB in candidateBeamRSList which is quasi-colocated with the selected CSI-RS as specified in TS 38.214 [7].
   2> else:
      3> set the PREAMBLE_INDEX to a ra-PreambleIndex corresponding to the selected SSB or CSI-RS from the set of Random Access Preambles for beam failure recovery request.
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSS;
   2> set the PREAMBLE_INDEX to a ra-PreambleIndex corresponding to the selected CSI-RS.
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> else if Msg3 buffer is empty:
      3> if Random Access Preambles group B is configured:
         4> if the potential Msg3 size (UL data available for transmission plus MAC subheader(s) and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—messagePowerOffsetGroupB; or
         4> if the Random Access procedure was initiated for the CCCH logical channel and the CCCH SDU size plus MAC subheader is greater than ra-Msg3SizeGroupA:
         5> select the Random Access Preambles group B.
         4> else:
         5> select the Random Access Preambles group A.
      3> else:
         4> select the Random Access Preambles group A.
   2> else (i.e. Msg3 is being retransmitted):
      3> select the same group of Random Access Preambles as was used for the Random Access Preamble transmission attempt corresponding to the first transmission of Msg3.
   2> select a Random Access Preamble randomly with equal probability from the Random Access Preambles associated with the selected SSB and the selected Random Access Preambles group;
   2> set the PREAMBLE_INDEX to the selected Random Access Preamble.
1> if the Random Access procedure was initiated for SI request (as specified in TS 38.331 [5]); and
1> if ra-AssociationPeriodIndex and si-RequestPeriod are configured:
   2> determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions according to clause 8.1 of TS 38.213 [6] corresponding to the selected SSB).
1> else if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB).
1> perform the Random Access Preamble transmission procedure (see clause 5.1.3).

### 5.1.3 Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
1> if LBT failure indication is received from lower layers for this Random Access Preamble transmission:
   2> if/bt-FailureRecoveryConfig is configured:
      3> perform the Random Access Resource selection procedure (see clause 5.1.2).
   2> else:
      3> increment PREAMBLE_TRANSMISSION_COUNTER by 1;
      3> if PREAMBLE_TRANSMISSION_COUNTER=preambleTransMax+1:
         4> if the Random Access Preamble is transmitted on the SpCell:
         5> indicate a Random Access problem to upper layers;
         5> if this Random Access procedure was triggered for SI request:
         6> consider the Random Access procedure unsuccessfully completed.
         4> else if the Random Access Preamble is transmitted on an SCell:
         5> consider the Random Access procedure unsuccessfully completed.
      3> if the Random Access procedure is not completed:
         4> perform the Random Access Resource selection procedure (see clause 5.1.2).

In addition, 3GPP TS 38.331 states:

### 5.2.2.3.3 Request for on Demand System Information

The UE shall, while SDT procedure is not ongoing:
1> if SIB1 includes si-SchedulingInfo containing si-RequestConfigSUL and criteria to select supplementary uplink as defined in TS 38.321 [3], clause 5.1.1 is met:
   2> trigger the lower layer to initiate the Random Access procedure on supplementary uplink in accordance with TS 38.321 [3] using the PRACH preamble(s) and PRACH resource(s) in si-RequestConfigSUL corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else if the UE is a RedCap UE and if initialUplinkBWP-RedCap is configured in UplinkConfigCommonSIB and if SIB1 includes si-SchedulingInfo containing si-RequestConfigRedCap and criteria to select normal uplink as defined in TS 38.321 [3], clause 5.1.1 is met:
   2> trigger the lower layer to initiate the Random Access procedure on normal uplink in accordance with TS 38.321 [3] using the PRACH preamble(s) and PRACH resource(s) in si-RequestConfigRedcap corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else:
   2> if the UE is not a RedCap UE and if SIB1 includes si-SchedulingInfo containing si-RequestConfig and criteria to select normal uplink as defined in TS 38.321 [3], clause 5.1.1 is met; or
   2> if the UE is a RedCap UE and if initialUplinkBWP-RedCap is not configured in UplinkConfigCommonSIB and if SIB1 includes si-SchedulingInfo containing si-RequestConfig and criteria to select normal uplink as defined in TS 38.321 [3], clause 5.1.1 is met:
      3> trigger the lower layer to initiate the Random Access procedure on normal uplink in accordance with TS 38.321 [3] using the PRACH preamble(s) and PRACH resource(s) in si-RequestConfig corresponding to the SI message(s) that the UE requires to operate within the cell, and for which si-BroadcastStatus is set to notBroadcasting;
      3> if acknowledgement for SI request is received from lower layers:
         4> acquire the requested SI message(s) as defined in clause 5.2.2.3.2, immediately;
   2> else:
      3> apply the default L1 parameter values as specified in corresponding physical layer specifications except for the parameters for which values are provided in SIB1;
      3> apply the default MAC Cell Group configuration as specified in 9.2.2;
      3> apply the timeAlignmentTimerCommon included in SIB1;
      3> apply the CCCH configuration as specified in 9.1.1.2;
      3> initiate transmission of the RRCSystemInfoRequest message with rrcSystemInfoRequest in accordance with 5.2.2.3.4;
      3> if acknowledgement for RRCSystemInfoRequest message with rrcSysteminfoRequest is received from lower layers:
         4> acquire the requested SI message(s) as defined in clause 5.2.2.3.2, immediately;

### SIB1

SIB1 contains information relevant when evaluating if a UE is allowed to access a cell and defines the scheduling of other system information. It also contains radio resource configuration information that is common for all UEs and barring information applied to the unified access control.
Signalling radio bearer: N/A
RLC-SAP: TM
Logical channels: BCCH
Direction: Network to UE

### SIB1 Message

| | |
|---|---|
| -- ASN1START | |
| -- TAG-SIB1-START | |
| SIB1 ::= | SEQUENCE { |
| ... | |
| si-SchedulingInfo | SI-SchedulingInfo |
| OPTIONAL, -- Need R | |
| servingCellConfigCommon | ServingCellConfigCommonSIB |
| OPTIONAL, -- Need R | |

### ServingCellConfigCommonSIB

The IE ServingCellConfigCommonSIB is used to configure cell specific parameters of a UE's serving cell in SIB1.

### ServingCellConfigCommonSIB Information Element

| | |
|---|---|
| -- ASN1START | |
| -- TAG-SERVINGCELLCONFIGCOMMONSIB-START | |
| ServingCellConfigCommonSIB ::= | SEQUENCE { |
| downlinkConfigCommon | DownlinkConfigCommonSIB, |
| uplinkConfigCommon | UplinkConfigCommonSIB |
| OPTIONAL, -- Need R | |
| supplementaryUplink | UplinkConfigCommonSIB |
| OPTIONAL, -- Need R | |

### UplinkConfigCommonSIB

The IE UplinkConfigCommonSIB provides common uplink parameters of a cell.

### UplinkConfigCommonSIB Information Element

| | |
|---|---|
| -- ASN1START | |
| -- TAG-UPLINKCONFIGCOMMONSIB-START | |
| UplinkConfigCommonSIB ::= | SEQUENCE { |
| frequencyInfoUL | FrequencyInfoUL-SIB, |
| initialUplinkBWP | BWP-UplinkCommon, |
| timeAlignmentTimerCommon | TimeAlignmentTimer |

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

### BWP-UplinkCommon Information Element

-- ASN1START
-- TAG-BWP-UPLINKCOMMON-START

| | |
|---|---|
| BWP-UplinkCommon ::= | SEQUENCE { |
| genericParameters | BWP, |
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M

| | |
|---|---|
| pucch-ConfigCommon | SetupRelease { PUCCH-ConfigCommon } |

```
OPTIONAL, -- Need M
  ...,
  [[
```

| | |
|---|---|
| rach-ConfigCommonIAB-r16 | SetupRelease { RACH-ConfigCommon } |

OPTIONAL, -- Need M

| | |
|---|---|
| useInterlacePUCCH-PUSCH-r16 | ENUMERATED {enabled} |

OPTIONAL, -- Need R

| | |
|---|---|
| msgA-ConfigCommon-r16 | SetupRelease { MsgA-ConfigCommon-r16 } |

```
OPTIONAL -- Cond SpCellOnly2
  ]],
  [[
  enableRA-PrioritizationForSlicing-r17 BOOLEAN
OPTIONAL, -- Cond RA-PrioSliceAI
```

| | |
|---|---|
| additionalRACH-ConfigList-r17 | SetupRelease { AdditionalRACH-ConfigList-r17 } |

OPTIONAL, -- Cond SpCellOnly2

| | |
|---|---|
| rsrp-ThresholdMsg3-r17 | RSRP-Range |

OPTIONAL, -- Need R

| | |
|---|---|
| numberOfMsg3-RepetitionsList-r17 | SEQUENCE (SIZE (4)) OF NumberOfMsg3-Repetitions-r17 |

OPTIONAL, -- Cond Msg3Rep

| | |
|---|---|
| mcs-Msg3-Repetitions-r17 | SEQUENCE (SIZE (8)) OF INTEGER (0..31) |

OPTIONAL -- Cond Msg3Rep
]]
}

| | |
|---|---|
| AdditionalRACH-ConfigList-r17 ::= | SEQUENCE (SIZE(1..maxAdditionalRACH-r17)) OF |

AdditionalRACH-Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
...
}

| | |
|---|---|
| NumberOfMsg3-Repetitions-r17::= | ENUMERATED {n1, n2, n3, n4, n7, n8, n12, n16} |

-- TAG-BWP-UPLINKCOMMON-STOP
-- ASN1STOP

### RACH-ConfigCommon

The IE RACH-ConfigCommon is used to specify the cell specific random-access parameters.

### RACH-ConfigCommon Information Element

-- ASN1START
-- TAG-RACH-CONFIGCOMMON-START

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5, spare4, |

spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}
OPTIONAL, -- NEED R

| | |
|---|---|
| ra-ContentionResolutionTimer | ENUMERATED { sf8, sf16, sf24, sf32, sf40, sf48, sf56, |

sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SOL

| | |
|---|---|
| prach-RootSequenceIndex | CHOICE { |
| l839 | INTEGER (0..837), |
| l139 | INTEGER (0..137) |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} |

```
OPTIONAL, -- Need R
  ...,
  [[
```

| | |
|---|---|
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |

}
OPTIONAL, -- Cond InitialBMP-Only

| | |
|---|---|
| prach-RootSequenceIndex-r16 | CHOICE { |
| l571 | INTEGER (0..569), |
| l1151 | INTEGER (0..1149) |

```
  } OPTIONAL -- Need R
  ]],
  [[
```

| | |
|---|---|
| ra-PrioritizationForSlicing-r17 | RA-PrioritizationForSlicing-r17 |

OPTIONAL, -- Cond InitialBMP-Only

| | |
|---|---|
| featureCombinationPreamblesList-r17 | SEQUENCE |

(SIZE(1..maxFeatureCombPreamblesPerRACHResource-r17)) OF FeatureCombinationPreambles-r17 OPTIONAL
-- Cond AdditionalRACH
]]
}
-- TAG-RACH-CONFIGCOMMON-STOP
-- ASN1STOP

RACH-ConfigCommon field descriptions

featureCombinationPreamblesList
Specifies a series of preamble partitions each associated to a combination of features and 4-step RA.
The network does not configure this list to have more than 16 entries.
messagePowerOffsetGroupB
Threshold for preamble selection. Value is in dB. Value minusinfinity corresponds to −infinity. Value
dB0 corresponds to 0 dB, dB5 corresponds to 5 dB and so on. (see TS 38.321 [3], clause 5.1.2)
msg1-SubcarrierSpacing
Subcarrier spacing of PRACH (see TS 38.211 [16], clause 5.3.2).
Only the following values are applicable depending on the used frequency:
FR1: 15 or 30 kHz
FR2-1: 60 or 120 kHz
FR2-2: 120, 480, or 960 kHz
If absent, the UE applies the SCS as derived from the prach-ConfigurationIndex in RACH-ConfigGeneric
(see tables Table 6.3.3.1-1, Table 6.3.3.1-2, Table 6.3.3.2-2 and Table 6.3.3.2-3, TS 38.211 [16]). The
value also applies to contention free random access (RACH-ConfigDedicated), to SI-request and to
contention-based beam failure recovery (CB-BFR). But it does not apply for contention free beam
failure recovery (CF-BFR) (see BeamFailureRecoveryConfig).
msg3-transformPrecoder
Enables the transform precoder for Msg3 transmission according to clause 6.1.3 of TS 38.214 [19]. If
the field is absent, the UE disables the transformer precoder (see TS 38.213 [13], clause 8.3).
numberOfRA-PreamblesGroupA
The number of CB preambles per SSB in group A. This determines implicitly the number of CB
preambles per SSB available in group B. (see TS 38.321 [3], clause 5.1.1). The setting should be
consistent with the setting of ssb-perRACH-OccasionAndCB-PreamblesPerSSB.
prach-RootSequenceIndex
PRACH root sequence index (see TS 38.211 [16], clause 6.3.3.1). The value range depends on whether
L = 839 or L = 139 or L = 571 or L = 1151. The length of the root sequence corresponding with the index
indicated in this IE should be consistent with the one indicated in prach-ConfigurationIndex in the
RACH-ConfigDedicated (if configured). If prach-RootSequenceIndex-r16 is signalled, UE shall ignore the
prach-RootSequenceIndex (without suffix).
For FR2-2, only the following values are applicable depending on the used subcarrier spacing:
120 kHz: L = 139, L = 571, and L = 1151
480 kHz: L = 139, and L = 571
960 kHz: L = 139
ra-ContentionResolutionTimer
The initial value for the contention resolution timer (see TS 38.321 [3], clause 5.1.5). Value sf8
corresponds to 8 subframes, value sf16 corresponds to 16 subframes, and so on.
ra-Msg3SizeGroupA
Transport Blocks size threshold in bits below which the UE shall use a contention-based RA preamble
of group A. (see TS 38.321 [3], clause 5.1.2).
ra-Prioritization
Parameters which apply for prioritized random access procedure on any UL BWP of SpCell for specific
Access Identities (see TS 38.321 [3], clause 5.1.1a).
ra-PrioritizationForAI
Indicates whether the field ra-Prioritization-r16 applies for Access Identities. The first/leftmost bit
corresponds to Access Identity 1, the next bit corresponds to Access Identity 2. Value 1 indicates that
the field ra-Prioritization-r16 applies otherwise the field does not apply (see TS 23.501 [32]).
ra-PrioritizationForSlicing
Parameters which apply to configure prioritized CBRA 4-step random access type for slicing.
rach-ConfigGeneric
RACH parameters for both regular random access and beam failure recovery.
restrictedSetConfig
Configuration of an unrestricted set or one of two types of restricted sets, see TS 38.211 [16], clause
6.3.3.1.
rsrp-ThresholdSSB
UE may select the SS block and corresponding PRACH resource for path-loss estimation and
(re)transmission based on SS blocks that satisfy the threshold (see TS 38.213 [13]).
rsrp-ThresholdSSB-SUL
The UE selects SUL carrier to perform random access based on this threshold (see TS 38.321 [3],
clause 5.1.1). The value applies to all the BWPs and all RACH configurations.
ssb-perRACH-OccasionAndCB-PreamblesPerSSB
The meaning of this field is twofold: the CHOICE conveys the information about the number of SSBs
per RACH occasion. Value oneEighth corresponds to one SSB associated with 8 RACH occasions, value
oneFourth corresponds to one SSB associated with 4 RACH occasions, and so on. The ENUMERATED
part indicates the number of Contention Based preambles per SSB. Value n4 corresponds to 4
Contention Based preambles per SSB, value n8 corresponds to 8 Contention Based preambles per SSB,
and so on. The total number of CB preambles in a RACH occasion is given by CB-preambles-per-SSB *
max(1, SSB-per-rach-occasion). See TS 38.213 [13].
totalNumberOfRA-Preambles
Total number of preambles used for contention based and contention free 4-step or 2-step random
access in the RACH resources defined in RACH-ConfigCommon, excluding preambles used for other
purposes (e.g. for SI request). If the field is absent, all 64 preambles are available for RA. The setting
should be consistent with the setting of ssb-perRACH-OccasionAndCB-PreamblesPerSSB, i.e. it should
be a multiple of the number of SSBs per RACH occasion.

| Conditional Presence | Explanation |
|---|---|
| AdditionalRACH | The field is mandatory present if the RACH-ConfigCommon is |
| | included in an AdditionalRACH-Config. When included in |
| | initialUplinkBWP-RedCap to indicate other feature(s) than |
| | redcap, this field is mandatory present with at least two |
| | FeatureCombinationPreambles list entries: one list entry |
| | indicating only redcap and the other(s) indicating both |
| | redcap and one or multiple other feature(s) (e.g. smallData, |
| | nsag or msg3-Repetitions). |
| | Otherwise, it is optional, Need R. |
| InitialBWP-Only | This field is optionally present, Need R, if this BWP is the |
| | initial BWP of SpCell. Otherwise, the field is absent. |
| L139 | The field is mandatory present if prach-RootSequenceIndex |
| | L = 139, otherwise the field is absent, Need S. |
| SUL | The field is mandatory present in rach-ConfigCommon in |
| | initialUplinkBWP if supplementaryUplink is configured in |
| | ServingCellConfigCommonSIB or if |
| | supplementaryUplinkConfig is configured in |
| | ServingCellConfigCommon; otherwise, the field is absent. |
| | This field is not configured in additionalRACH-Config. |

### RACH-ConfigGeneric

The IE RACH-ConfigGeneric is used to specify the random-access parameters both for regular random access as well as for beam failure recovery.

### RACH-ConfigGeneric Information Element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED |
| {scf1,scf2,scf4,scf8,scf16,scf32,scf64} | OPTIONAL, -- Need R |
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { s160, sl160} |

OPTIONAL, -- Need R

| | |
|---|---|
| prach-ConfigurationIndex-v1610 | INTEGER (256..262) |

```
OPTIONAL -- Need R
  ]],
  [[
```

| | |
|---|---|
| ra-ResponseWindow-v1700 | ENUMERATED {sl240, sl320, sl640, sl960, sl1280, |

sl1920, sl2560} OPTIONAL -- Need R
]]
}
-- TAG-RACH-CONFIGGENERIC-STOP
-- ASN1STOP

RACH-ConfigGeneric field descriptions

msg1-FDM
The number of PRACH transmission occasions FDMed in one time instance. (see TS 38.211 [16],
clause 6.3.3.2).
msg1-FrequencyStart
Offset of lowest PRACH transmission occasion in frequency domain with respective to PRB 0. The
value is configured so that the corresponding RACH resource is entirely within the bandwidth of
the UL BWP. (see TS 38.211 [16], clause 6.3.3.2).
powerRampingStep
Power ramping steps for PRACH (see TS 38.321 [3], 5.1.3).
prach-ConfigurationFrameOffset-IAB
Frame offset for ROs defined in the baseline configuration indicated by prach-ConfigurationIndex
and is used only by the IAB-MT. (see TS 38.211 [16], clause 6.3.3.2).
prach-ConfigurationIndex
PRACH configuration index. For prach-ConfigurationIndex configured under
beamFailureRecoveryConfig, the prach-ConfigurationIndex can only correspond to the short
preamble format, (see TS 38.211 [16], clause 6.3.3.2). If the field prach-ConfigurationIndex-v1610
is present, the UE shall ignore the value provided in prach-ConfigurationIndex (without suffix).
prach-ConfigurationPeriodScaling-IAB
Scaling factor to extend the periodicity of the baseline configuration indicated by prach-
ConfigurationIndex and is used only by the IAB-MT. Value scf1 corresponds to scaling factor of 1
and so on. (see TS 38.211 [16], clause 6.3.3.2).
prach-ConfigurationSOffset-IAB
Subframe/Slot offset for ROs defined in the baseline configuration indicated by prach-
ConfigurationIndex and is used only by the IAB-MT. (see TS 38.211 [16], clause 6.3.3.2).
preambleReceivedTargetPower
The target power level at the network receiver side (see TS 38.213 [13], clause 7.4, TS 38.321 [3],
clauses 5.1.2, 5.1.3). Only multiples of 2 dBm may be chosen (e.g. −202, −200, −198, . . . ).
preambleTransMax
Max number of RA preamble transmission performed before declaring a failure (see TS 38.321
[3], clauses 5.1.4, 5.1.5).
ra-ResponseWindow
Msg2 (RAR) window length in number of slots. The network configures a value lower than or
equal to 10 ms when Msg2 is transmitted in licensed spectrum and a value lower than or equal to
40 ms when Msg2 is transmitted with shared spectrum channel access (see TS 38.321 [3], clause
5.1.4). UE ignores the field if included in SCellConfig. If ra-ResponseWindow-v1610 or ra-
ResponseWindow-v1700 is signalled, UE shall ignore the ra-ResponseWindow (without suffix). The
field ra-ResponseWindow-v1700 is applicable to SCS 480 kHz and SCS 960 kHz.
zeroCorrelationZoneConfig
N-CS configuration, see Table 6.3.3.1-5 in TS 38.211 [16].

### SI-RequestConfig

The IE SI-RequestConfig contains configuration for Msg1 based SI request.

### SI-RequestConfig Information Element

-- ASN1START
-- TAG-SI-REQUESTCONFIG-START

| | |
|---|---|
| SI-RequestConfig ::= | SEQUENCE { |
| rach-OccasionsSI | SEQUENCE { |
| rach-ConfigSI | RACH-ConfigGeneric, |
| ssb-perRACH-Occasion | ENUMERATED {oneEighth, oneFourth, oneHalf, one, two, |

four, eight, sixteen}
}
OPTIONAL, -- Need R

| | |
|---|---|
| si-RequestPeriod | ENUMERATED {one, two, four, six, eight, ten, twelve, |

sixteen} OPTIONAL, -- Need R

| | |
|---|---|
| si-RequestResources | SEQUENCE (SIZE (1..maxSI-Message)) OF SI-RequestResources |

}

| | |
|---|---|
| SI-RequestResources ::= | SEQUENCE { |
| ra-PreambleStartIndex | INTEGER (0..63), |
| ra-AssociationPeriodIndex | INTEGER (0..15) |

OPTIONAL, -- Need R

| | |
|---|---|
| ra-ssb-OccasionMaskIndex | INTEGER (0..15) |

OPTIONAL -- Need R
}
-- TAG-SI-REQUESTCONFIG-STOP
-- ASN1STOP

Network energy saving is introduced to save power from base station perspective. Energy could be saved by reducing the transmission/reception occasion(s) in time domain. For example, during a period of time that no transmission/reception is performed, the corresponding hardware component(s) could be turn off completely (e.g. go to deep sleep) so that power consumption is reduced. Therefore, from power saving perspective, it would be more preferred to perform/finish transmission/reception within a certain period (e.g. a condensed period) and turn off transmission reception outside the certain period (e.g. for a longer period of time). There could be a trade-off that larger latency would be induced since the opportunities to transmit/receive is reduced. Common signal could be a source of an always turn-on signal irrespective of whether there is ongoing traffic. For example, common signal (e.g. SSB (Synchronization Signal Block), SS (Synchronization Signal)/PBCH (Physical Broadcast Channel) block, SIB1, SIB (System Information Block), paging, PRACH (Physical Random Access Channel)) is broadcasted and/or could be used for all UEs in the cell, e.g. including UE not yet access the cell. Therefore, reducing the transmission/reception of common signal would become an attractive solution to network energy saving. More details regarding network energy saving is discussed and provided below in 3GPP RP-234065:
1. Study procedures and signaling method(s) to support on-demand SIB1 for UEs in idle/inactive mode, including: [RAN1/2/3]
   Triggering method by uplink wake-up-signal using an existing signal/channel.
   Wake-up-signal configuration provisioning to UE
      Note: No modification of SSB will be discussed under this objective
   Information exchange between gNBs at least for the configuration of wake-up signal, if necessary.
   Checkpoint for normative work in RAN #105
2. Specify adaptation of common signal/channel transmissions. [RAN1/2/3/4]
   Adaptation of SSB in time domain, e.g. adapting periodicity
   Adaptation of PRACH in time domain Study adaptation of PRACH in spatial domain, e.g. non-uniform PRACH resources per SSB, and specify if found beneficial
      This study is to be done in 2Q′2024 only
   Adaptation of paging occasions including confining the paging occasions in the time domain
      Note: there shall be no paging latency increase
   Note: there shall be no negative impact to legacy UEs, unless significant benefits are shown
3. Specify the corresponding core requirements, for the above features [RAN4].

As shown and discussed above, SIB1 would provide cell-specific Physical Random Access Channel (PRACH) configuration, e.g. RACH-ConfigCommon, for UE. The UE could perform random access procedure based on the PRACH configuration. For example, the UE could know available PRACH resource, preamble sequence related configuration, association between Synchronization Signal Block (SSB) and preamble sequence/PRACH resource based on the PRACH configuration. The PRACH configuration would consider several aspects, e.g. latency induced by random access procedure, to provide parameters for random access procedure for various purposes, e.g. connection setup/handover/request for UL grant/acquiring Uplink (UL) Timing Advance (TA)/recovery from beam failure, etc. These purposes are mainly for cell operating under normal situation (e.g. with respect to power consumption), so that the density of PRACH resource should not be too sparse to avoid long delay induced by random access procedure.

While for PRACH resource for request on demand SIB1, the base station operates under low power consumption during such period, and thus a too dense PRACH resource would have negative impact on power consumption, e.g. base station has to wake up or turn on to receive/detect potential preamble from the UE(s) more frequently. Besides, the usage of preamble may also be different for on demand SIB1 and other purposes. When cell operates under normal/regular power consumption, random access procedure could be initiated for various purposes mentioned above as well as various types of UE so that PRACH has to be partitioned for these purposes and/or types of UE, e.g. different preambles and/or different PRACH could be associated with different purposes and/or different types of UE. On the other hand, when cell operates under low power consumption, the purpose to initiate random access is rather limited, e.g. mainly for requesting SIB1, so that partition PRACH is not necessary. When partition is not necessary, base station also have some more freedom to allocate preamble sequence so that intercell interference caused by PRACH could be reduced. Therefore, when SIB1 is not provided and/or on demand, how a UE obtain a proper PRACH configuration used for requesting SIB 1 would require some further thoughts.

A first general concept of this invention is to utilize two different PRACH configurations and/or parameters (e.g. all or some configuration(s)/parameter(s) in RACH-ConfigCommon) when SIB1 is provided and when SIB1 is not provided. One PRACH configuration(s) and/or parameter(s) is used when SIB1 is provided. One PRACH configuration(s) and/or parameter(s) is used for RRC connection establishment and/or for requesting UL grant and/or handover and/or acquiring UL TA and/or for beam failure recovery and/or requesting SI other than SIB1. Another PRACH configuration(s) and/or parameter(s) is used when SIB1 is not provided. Another PRACH configuration(s) and/or parameter(s) is used for requesting SIB1. The two different PRACH configurations and/or parameters could be provided in same or different message(s).

One PRACH configuration(s) and/or parameter(s) could be provided by SIB1. Another PRACH configuration(s) and/or parameter(s) could be predefined or specified or fixed or preconfigured. Another PRACH configuration(s) and/or parameter(s) could be provided by Radio Resource Control (RRC) message (e.g. RRC reconfiguration message or RRC release message). Another PRACH configuration(s) and/or parameter(s) could be provided when UE was in RRC connected mode/state. Another PRACH configuration(s) and/or parameter(s) could be provided by SIB or SIB1 (e.g. provided before or provided last time or last valid SIB/SIB1). Another PRACH configuration(s) and/or parameter(s) could be provided or indicated by Master Information Block (MIB). Multiple (sets of) candidate values for another configurations could be predefined or specified or fixed or preconfigured or provided by RRC message (e.g. when UE was in RRC connected mode/state) or provided by SIB/SIB1 (e.g. provided before or provided last time or last valid SIB/SIB1). MIB could indicate which (set of) candidate value is used or applied.

The UE could initiate a random access for requesting SIB1 based on another PRACH configuration(s) and/or parameter(s). Note that different configurations/parameters in another PRACH configuration(s) and/or parameter(s) could be derived/indicated differently, e.g. some could be predefined or specified or fixed or preconfigured and/or some could be provided/indicated by a message (e.g. MIB/SIB/SIB 1/RRC message) and/or some could reuse the value in one PRACH configuration(s) and/or parameter(s). A single preamble index could be used for requesting SIB1. The single preamble index could be fixed, e.g. 0 or 000000. The single preamble index could be indicated.

Using different root sequences for PRACH (e.g. prach-RootSequenceIndex) for the case SIB1 is provided and for the case SIB1 is not provided would help the base station to control the inter-cell interference caused by preamble. When SIB1 is provided, e.g. when base station operate normally, the PRACH capacity is required for various purposes, so that one cell is usually allocated with 64 preamble which may come from a single root sequence or multiple root sequence(s) (e.g. depending on sequence length and/or cyclic shift). In other words, it typically means different cells is likely to utilize different root sequences. Preamble sequence (e.g. Zadoff-Chu sequence) has the property of ideal auto-correlation property and low cross-correlation property. In other words, sequences from a single root sequence with proper cyclic shift isolation would cause zero interference to each other, while sequences from different root sequences would cause low interference to each other. Therefore, when cell provides SIB1, e.g. when cells operate under normal operation, different root sequences are assigned to different cells to provide proper PRACH capacity.

When cell does not provide SIB1, e.g. when cells operates with low power consumption, the same root sequence and/or different cyclic shifts are assigned to different cells (e.g. to benefit from the ideal auto-correlation property). For example, when SIB1 is provided for Cell A/B/C, Cell A may use root sequence X to derive preambles based on cyclic shift values CS1, CS 2, CS3, . . . , Cell B may use root sequence Y to derive preambles based on cyclic shift values CS1, CS 2, CS3, . . . , and Cell C may use root sequence Z to derive preambles based on cyclic shift values CS1, CS 2, CS3, . . . . When SIB1 is not provided for Cell A/B/C, Cell A may use root sequence X to derive preamble(s) based on cyclic shift values CS1′ (CS 2′ . . . ), Cell B may use root sequence X to derive preamble(s) based on cyclic shift values CS3′ (CS 4′ . . . ), and Cell C may use root sequence X to derive preamble(s) based on cyclic shift values CS5′ (CS 6′, . . . ). This kind of assignment is possible by assigning different root sequences when SIB1 is provided and when SIB 1 is not provided. The interference cause by preambles with root sequence X and cyclic shift value CS1′, CS3′, CS5′, could be extremely low (e.g. 0).

PRACH configuration(s) and/or parameter(s) could be one or more of prach-ConfigurationIndex, msg1-FDM, msg1-FrequencyStart, zeroCorrelationZoneConfig, preambleReceivedTargetPower, preambleTransMax, powerRampingStep, ra-Response Window, ra-Response Window-v1610, prach-ConfigurationIndex-v1610, ra-Response Window-v1700, totalNumberOfRA-Preambles, ssb-perRACH-OccasionAndCB-PreamblesPerSSB, rsrp-ThresholdSSB, rsrp-ThresholdSSB-SUL, prach-RootSequenceIndex, restrictedSetConfig, msg3-transformPrecoder, ra-PrioritizationForAccessIdentity-r16, prach-RootSequenceIndex-r16, ra-PrioritizationForSlicing-r17, featureCombinationPreamblesList-r17, ssb-perRACH-Occasion, si-RequestPeriod, si-RequestResources, ra-PreambleStartIndex, ra-AssociationPeriodIndex, and ra-ssb-OccasionMaskIndex.

A second general concept of this invention is to derive PRACH configurations and/or parameters for requesting SIB1 based on PRACH configurations and/or parameters indicated in SIB1. PRACH configurations and/or parameters indicated in SIB 1 are used when/if SIB1 is provided. PRACH configurations and/or parameters indicated in SIB1 is used for other purpose (e.g. for RRC connection establishment and/or for requesting UL grant and/or handover and/or acquiring UL TA and/or for beam failure recovery and/or requesting SI other than SIB1). PRACH configurations and/or parameters for requesting SIB1 are used when/if SIB1 is not provided. PRACH configurations and/or parameters for requesting SIB1 are a subset of PRACH configurations and/or parameters indicated in SIB1.

The derivation is to select a subset of (available) PRACH (time/frequency) resource(s)/occasion(s) and/or preamble(s) for requesting SIB1. The derivation is to use some/part of PRACH (time/frequency) resource(s)/occasion(s) and/or preamble(s) for requesting SIB1 and/or not to use some/part of PRACH (time/frequency) resource(s)/occasion(s) and/or preamble(s) for requesting SIB1. PRACH (time/frequency) resource(s)/occasion(s) and/or preamble(s) for requesting SIB1 could be used for other purpose when/if SIB 1 is provided. PRACH (time/frequency) resource(s)/occasion(s) and/or preamble(s) not used for requesting SIB1 is not used for other purpose(s) when/if SIB 1 is not provided.

The derivation is based on an indication in a message (e.g. MIB/SIB/SIB1/RRC message). The derivation is based on a predefined rule. The derivation is based on a periodicity of SSB. The derivation is based on a transmission occasion of SSB. The derivation is based on a relative position of PRACH (time/frequency) resource(s)/occasion(s) and/or preamble(s) to a transmission (time/frequency) occasion of SSB. The derivation is based on a ratio or proportion, e.g. 10%. For example, the indication could be a mask which indicate which PRACH (time/frequency) resource(s)/occasion(s) and/or preamble(s) is to be used for requesting SIB1 and/or which PRACH (time/frequency) resource(s)/occasion(s) and/or preamble(s) is not to be used for requesting SIB1. For example, the first PRACH (e.g. after one or each SSB and/or associated with one or each SSB and/or within each SSB period) is to be used for requesting SIB1 and/or the rest PRACH (time/frequency) resource(s)/occasion(s) and/or preamble(s) is not to be used for requesting SIB1. The periodicity of PRACH resource for requesting SIB1 could be based on periodicity of SSB. The periodicity of PRACH resource for requesting SIB1 is not based on indication of SIB1 for PRACH (e.g. prach-ConfigurationIndex).

In one embodiment, a UE initiates a first random access procedure to request a first system information. The UE initiates a first random access procedure to request a first system information when the first system information is not provided. The UE initiates the first random access procedure based on a first parameter and/or a first configuration and/or a first value of a parameter(s) and/or a first value of a configuration. The first random access procedure could be a contention based random access procedure. The first random access procedure could be a non-contention based random access procedure. The UE could select preamble an/or PRACH based on a first parameter and/or a first configuration and/or a first value of a parameter(s) and/or a first value of a configuration The UE initiates a second random access procedure when the first system information is provided. The UE initiates a second random access procedure for one or more of: RRC connection establishment, RRC connection resume, requesting UL grant, handover, acquiring UL TA, beam failure recovery, or requesting a second system information. The UE initiates the second random access procedure based on a second parameter and/or a second configuration and/or a second value of the parameter(s) and/or a second value of the configuration. The UE initiates the second random access procedure based on a second parameter and/or a second configuration and/or a second value of the parameter(s) and/or a second value of the configuration when/if the first system information is provided.

The second parameter and/or the second configuration and/or the second value of the parameter(s) and/or the second value of the configuration is provided by the first system information. The first parameter and/or the first configuration and/or the first value of the parameter(s) and/or the first value of the configuration is used for random access procedure for requesting the first system information. The first parameter and/or the first configuration and/or the first value of the parameter(s) and/or the first value of the configuration is used when/if the first system information is not provided. The first parameter and/or the first configuration and/or the first value of the parameter(s) and/or the first value of the configuration is provided or indicated in the first system information. The first parameter and/or the first configuration and/or the first value of the parameter(s) and/or the first value of the configuration is provided or indicated in the first system information provided previously. The first parameter and/or the first configuration and/or the first value of the parameter(s) and/or the first value of the configuration is provided or indicated in the latest valid first system information.

The UE stores the corresponding information in the first system information when/if the first system information is provided and utilize the store information when/if the first system information is not provided. The first parameter and/or the first configuration and/or the first value of the parameter(s) and/or the first value of the configuration is provided or indicated when the first system information was provided (e.g. previously). The first parameter and/or the first configuration and/or the first value of the parameter(s) and/or the first value of the configuration is provided or indicated in MIB. The first parameter and/or the first configuration and/or the first value of the parameter(s) and/or the first value of the configuration is provided or indicated in a RRC message (e.g. reconfiguration message or release message). The first parameter and/or the first configuration and/or the first value of the parameter(s) and/or the first value of the configuration is provided or indicated when the UE was in RRC connected state.

The UE stores the corresponding information in the RRC message (e.g. when/if the first system information is provided and/or when the UE was in RRC connected state) and utilize the store information when/if the first system information is not provided (e.g. and/or when/if the UE is in RRC idle state or RRC inactive state). The first parameter and/or the first configuration and/or the first value of the parameter(s) and/or the first value of the configuration is predefined or preconfigured or fixed or specified (e.g. as a table). The first parameter and/or the first configuration and/or the first value of the parameter(s) and/or the first value of the configuration could be indicated from a set of candidates or a set of candidate values.

The set of candidates could be predefined or preconfigured or fixed or specified (e.g. as a table). The set of candidates could be provided by a RRC message (e.g. reconfiguration message or release message). The set of candidates could be provided by the first system information. The set of candidates could be provided by the second system information.

Parameter and/or configuration could be one or more parameter(s) and/or configuration provided in RACH-ConfigCommon. Parameter and/or configuration could be one or more of: prach-ConfigurationIndex, msg1-FDM, msg1-FrequencyStart, zeroCorrelationZoneConfig, preambleReceivedTargetPower, preambleTransMax, powerRampingStep, ra-ResponseWindow, ra-ResponseWindow-v1610, prach-ConfigurationIndex-v1610, ra-Response Window-v1700, totalNumberOfRA-Preambles, ssb-perRACH-OccasionAndCB-PreamblesPerSSB, rsrp-ThresholdSSB, rsrp-ThresholdSSB-SUL, prach-RootSequenceIndex, restrictedSetConfig, msg3-transformPrecoder, ra-PrioritizationForAccessIdentity-r16, prach-RootSequenceIndex-r16, ra-PrioritizationForSlicing-r17, featureCombinationPreamblesList-r17, ssb-perRACH-Occasion, si-RequestPeriod, si-RequestResources, ra-PreambleStartIndex, ra-AssociationPeriodIndex, and ra-ssb-OccasionMaskIndex. There could be a third parameter and/or a third configuration and/or a third value of the parameter(s) and/or a third value of the configuration used for initiating random access for requesting a second system information. The first system information could be SIB1. The first system information could be essential system information. The first system information could be SSB/MIB. The first system information could be SSB/MIB on another serving cell. The second system information could be other SI and/or non-essential SI. The second system information could be SIB other than SIB1 (e.g. SIBX where X is other than 1). The second system information could be SIB other than SIB1 on another serving cell.

In another embodiment, a UE initiates a first random access procedure to request a first system information. The UE initiates a first random access procedure to request a first system information when the first system information is not provided. The UE initiates the first random access procedure based on a first parameter and/or a first configuration and/or a first value of a parameter(s) and/or a first value of a configuration. The UE initiates the first random access procedure based on a first parameter and/or a first configuration and/or a first value of a parameter(s) and/or a first value of a configuration and at least one factor. The UE derives parameter and/or configuration for the first random access procedure based on a first parameter and/or a first configuration and/or a first value of a parameter(s) and/or a first value of a configuration. The UE derives parameter and/or configuration for the first random access procedure based on at least one factor. The UE derives parameter and/or configuration for the first random access procedure based on at least one factor and a first parameter and/or a first configuration and/or a first value of a parameter(s) and/or a first value of a configuration.

The at least one factor could be a periodicity of SSB. The at least one factor could be a transmission occasion(s) of SSB. The at least one factor could be a proportion or ratio. The at least one factor could be a mask. The mask could indicate which PRACH is available for the first random access procedure. The mask could indicate which PRACH is not available for the first random access procedure. The at least one factor could be applied on top of a first parameter and/or a first configuration and/or a first value of a parameter(s) and/or a first value of a configuration. The at least one factor could be a relative position of PRACH (time/frequency) resource(s)/occasion(s) and/or preamble(s) to a transmission (time/frequency) occasion of SSB.

The UE initiates a first random access procedure with the PRACH which is closest to an SSB. (Only) the PRACH which is closest to an SSB is valid or available for the first random access procedure. The PRACH which is closest to an SSB could be PRACH indicated by a first parameter and/or a first configuration and/or a first value of a parameter(s) and/or a first value of a configuration. Other PRACH indicated by a first parameter and/or a first configuration and/or a first value of a parameter(s) and/or a first value of a configuration could not be used or is not available for the first random access procedure.

The UE initiates a first random access procedure with the first PRACH after an SSB. (Only) the first PRACH after an SSB is valid or available for the first random access procedure. The first PRACH after an SSB could be PRACH indicated by a first parameter and/or a first configuration and/or a first value of a parameter(s) and/or a first value of a configuration. Other PRACH indicated by a first parameter and/or a first configuration and/or a first value of a parameter(s) and/or a first value of a configuration could not be used or is not available for the first random access procedure. The first random access procedure could be a contention based random access procedure. The first random access procedure could be a non-contention based random access procedure. The UE could select preamble an/or PRACH based on a first parameter and/or a first configuration and/or a first value of a parameter(s) and/or a first value of a configuration and at least one factor.

The UE initiates a second random access procedure when the first system information is provided. The UE initiates a second random access procedure for one or more of: RRC connection establishment, RRC connection resume, requesting UL grant, handover, acquiring UL TA, beam failure recovery, or requesting a second system information. The UE initiates the second random access procedure based on a first parameter and/or a first configuration and/or a first value of the parameter(s) and/or a first value of the configuration. The UE initiates the second random access procedure based on a first parameter and/or a first configuration and/or a first value of the parameter(s) and/or a first value of the configuration irrespective of at least one factor. The UE initiates the second random access procedure based on a first parameter and/or a first configuration and/or a first value of the parameter(s) and/or a first value of the configuration and not based on at least one factor. The UE initiates the second random access procedure based on a first parameter and/or a first configuration and/or a first value of the parameter(s) and/or a first value of the configuration when/if the first system information is provided. The UE initiates the second random access procedure based on a first parameter and/or a first configuration and/or a first value of the parameter(s) and/or a first value of the configuration irrespective of at least one factor when/if the first system information is provided. The UE initiates the second random access procedure based on a first parameter and/or a first configuration and/or a first value of the parameter(s) and/or a first value of the configuration and not based on at least one factor when/if the first system information is provided.

A first parameter and/or a first configuration and/or a first value of a parameter(s) and/or a first value of a configuration is provided by the first system information. A first parameter and/or a first configuration and/or a first value of a parameter(s) and/or a first value of a configuration is stored for initiate the first random access procedure when/if the first system information is not provided. The at least one factor could be fixed/predefined/preconfigured/configured/specified. The at least one factor could be indicated by a base station. The at least one factor could be indicated by a message (e.g. MIB/SIB/SIB1/RRC message).

The UE stores the corresponding information in the first system information when/if the first system information is provided and utilize the store information when/if the first system information is not provided. The first parameter and/or the first configuration and/or the first value of the parameter(s) and/or the first value of the configuration is provided or indicated when the first system information was provided (e.g. previously).

Parameter and/or configuration could be one or more parameter(s) and/or configuration provided in RACH-ConfigCommon. Parameter and/or configuration could be one or more of: prach-ConfigurationIndex, msg1-FDM, msg1-FrequencyStart, zeroCorrelationZoneConfig, preambleReceivedTargetPower, preambleTransMax, powerRampingStep, ra-ResponseWindow, ra-ResponseWindow-v1610, prach-ConfigurationIndex-v1610, ra-Response Window-v1700, totalNumberOfRA-Preambles, ssb-perRACH-OccasionAndCB-PreamblesPerSSB, rsrp-ThresholdSSB, rsrp-ThresholdSSB-SUL, prach-RootSequenceIndex, restrictedSetConfig, msg3-transformPrecoder, ra-PrioritizationForAccessIdentity-r16, prach-RootSequenceIndex-r16, ra-PrioritizationForSlicing-r17, featureCombinationPreamblesList-r17, ssb-perRACH-Occasion, si-RequestPeriod, si-RequestResources, ra-PreambleStartIndex, ra-AssociationPeriodIndex, and ra-ssb-OccasionMaskIndex. The first system information could be SIB1. The first system information could be essential system information. The first system information could be SSB/MIB. The first system information could be SSB/MIB on another serving cell. The second system information could be other SI and/or non-essential SI. The second system information could be SIB other than SIB1 (e.g. SIBX where X is other than 1). The second system information could be SIB other than SIB1 on another serving cell.

Note that the invention is described based on a 4-step random access procedure, while could be adopted or extended to a 2-step random access procedure by merging Msg1 and Msg3 to form a Msg A and by replace PRACH configuration/parameter for 4-step RACH with PRACH configuration/parameter for 2-step RACH.

Throughout the invention, “C-DRX” could be replaced by “DRX” or “DRX for a UE” or “UE DRX”.

Throughout the invention, the invention describes behavior or operation of a single serving cell unless otherwise noted.

Throughout the invention, the invention describes behavior or operation of multiple serving cells unless otherwise noted.

Throughout the invention, the invention describes behavior or operation of a single bandwidth part unless otherwise noted.

Throughout the invention, a base station configures multiple bandwidth parts to the UE unless otherwise noted.

Throughout the invention, a base station configures a single bandwidth part to the UE unless otherwise noted.

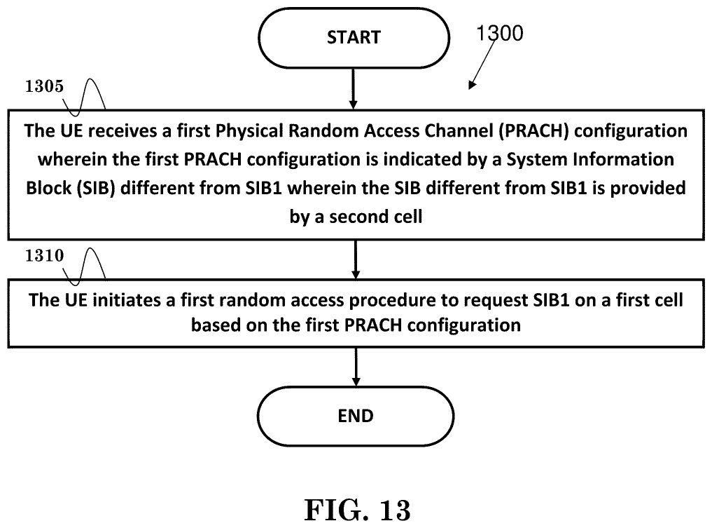

FIG. 13 is a flow chart 1300 for a User Equipment (UE). In step 1305, the UE receives a first Physical Random Access Channel (PRACH) configuration wherein the first PRACH configuration is indicated by a System Information Block (SIB) different from SIB1 wherein the SIB different from SIB1 is provided by a second cell. In step 1310, the UE initiates a first random access procedure to request SIB1 on a first cell based on the first PRACH configuration.

In one embodiment, the UE could receive a second PRACH configuration via SIB1. The UE could be indicated a second PRACH configuration via SIB1. The UE could receive a second PRACH configuration wherein the second PRACH configuration is indicated by SIB1. The UE could initiate a second random access procedure for a purpose other than requesting SIB1 based on the second PRACH configuration. The UE could initiate a second random access procedure for Radio Resource Control (RRC) connection establishment based on the second PRACH configuration. The UE could initiate a second random access procedure for requesting a system information different from SIB1 based on the second PRACH configuration.

Referring back to FIGS. 3 and 4, in one exemplary embodiment from the perspective of a UE. The UE 300 includes a program code 312 stored in the memory 310. The CPU 308 could execute program code 312 to enable the UE (i) to receive a first Physical Random Access Channel (PRACH) configuration wherein the first PRACH configuration is indicated by a System Information Block (SIB) different from SIB 1 wherein the SIB different from SIB 1 is provided by a second cell, and (ii) to initiate the first random access procedure to request SIB1 on a first cell based on the first PRACH configuration. Furthermore, the CPU 308 can execute the program code 312 to perform all of the above-described actions and steps or others described herein.

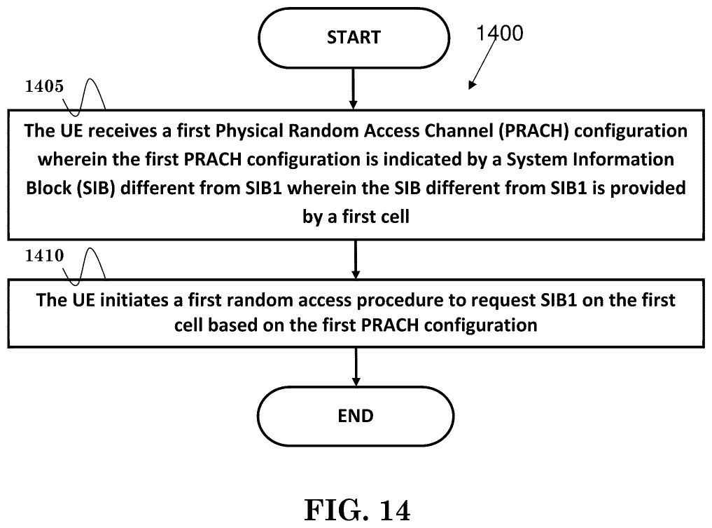

FIG. 14 is a flow chart 1400 for a User Equipment (UE). In step 1405, the UE receives a first Physical Random Access Channel (PRACH) configuration wherein the first PRACH configuration is indicated by a System Information Block (SIB) different from SIB1 wherein the SIB different from SIB1 is provided by a first cell. In step 1410, the UE initiates a first random access procedure to request SIB1 on the first cell based on the first PRACH configuration.

In one embodiment, the UE could receive a second PRACH configuration via SIB1. The UE could be indicated a second PRACH configuration via SIB1. The UE could receive a second PRACH configuration wherein the second PRACH configuration is indicated by SIB1. The UE could initiate a second random access procedure for a purpose other than requesting SIB1 based on the second PRACH configuration. The UE could initiate a second random access procedure for Radio Resource Control (RRC) connection establishment based on the second PRACH configuration. The UE could initiate a second random access procedure for requesting a system information different from SIB1 based on the second PRACH configuration.

Referring back to FIGS. 3 and 4, in one exemplary embodiment from the perspective of a UE. The UE 300 includes a program code 312 stored in the memory 310. The CPU 308 could execute program code 312 to enable the UE (i) to receive a first Physical Random Access Channel (PRACH) configuration wherein the first PRACH configuration is indicated by a System Information Block (SIB) different from SIB1 wherein the SIB different from SIB 1 is provided by a first cell, and (ii) to initiate a first random access procedure to request SIB1 on the first cell based on the first PRACH configuration. Furthermore, the CPU 308 can execute the program code 312 to perform all of the above-described actions and steps or others described herein.

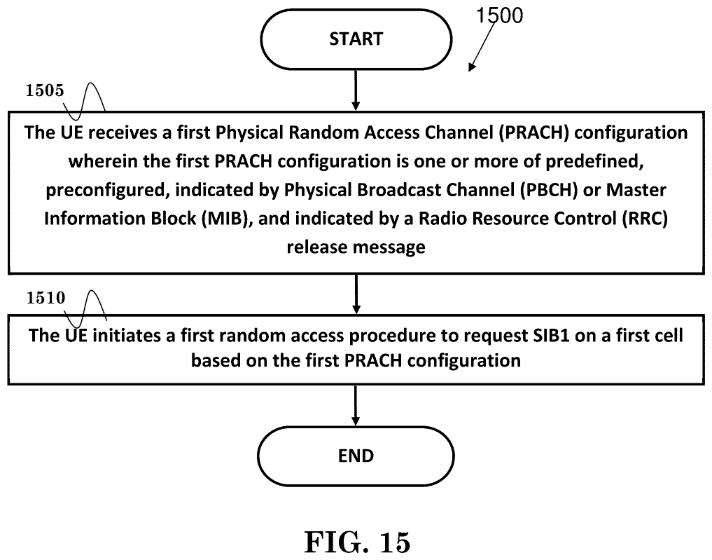

FIG. 15 is a flow chart 1500 for a User Equipment (UE). In step 1505, the UE receives a first Physical Random Access Channel (PRACH) configuration wherein the first PRACH configuration is one or more of predefined, preconfigured, indicated by Physical Broadcast Channel (PBCH) or Master Information Block (MIB), and indicated by a Radio Resource Control (RRC) release message. In step 1510, the UE initiates a first random access procedure to request SIB1 on a first cell based on the first PRACH configuration.

In one embodiment, the UE could receive a second PRACH configuration via SIB1. The UE could be indicated a second PRACH configuration via SIB1. The UE could receive a second PRACH configuration wherein the second PRACH configuration is indicated by SIB1. The UE could initiate a second random access procedure for a purpose other than requesting SIB1 based on the second PRACH configuration. The UE could initiate a second random access procedure for RRC connection establishment based on the second PRACH configuration. The UE could initiate a second random access procedure for requesting a system information different from SIB1 based on the second PRACH configuration.

Referring back to FIGS. 3 and 4, in one exemplary embodiment from the perspective of a UE. The UE 300 includes a program code 312 stored in the memory 310. The CPU 308 could execute program code 312 to enable the UE (i) to receives a first Physical Random Access Channel (PRACH) configuration wherein the first PRACH configuration is one or more of predefined, preconfigured, indicated by Physical Broadcast Channel (PBCH) or Master Information Block (MIB), and indicated by a Radio Resource Control (RRC) release message, and (ii) to initiate a first random access procedure to request SIB1 on a first cell based on the first PRACH configuration. Furthermore, the CPU 308 can execute the program code 312 to perform all of the above-described actions and steps or others described herein.

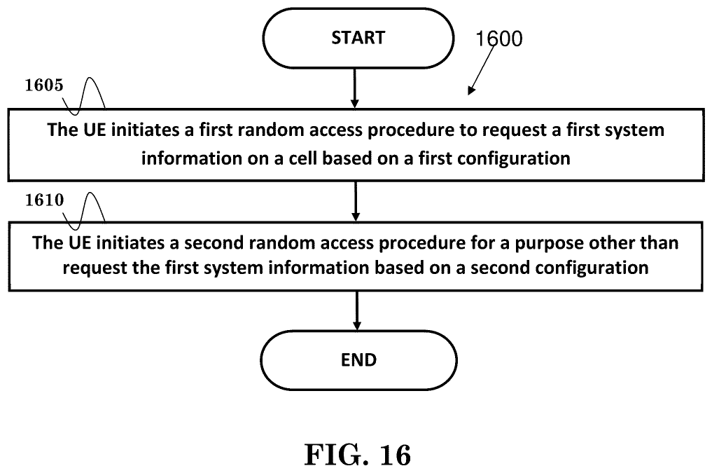

FIG. 16 is a flow chart 1600 for a User Equipment (UE). In step 1605, the UE initiates a first random access procedure to request a first system information on a cell based on a first configuration. In step 1610, the UE initiates a second random access procedure for a purpose other than request the first system information based on a second configuration.

In one embodiment, the first system information could be SIB1. The second configuration could be provided by the first system information. The second random access procedure could be initiated if the first system information is provided. The first random access procedure could be initiated if the first system information is not provided. The first configuration could be fixed or predefined or specified. The set of candidate values for the first configuration could be fixed or predefined or specified.

In one embodiment, the first configuration could be provided or indicated when the first system information was transmitted. The first configuration could be provided or indicated by the latest valid first system information. The first configuration could be provided or indicated by a second system information. The first configuration could be provided or indicated by a SSB or MIB. The first configuration could be provided or indicated by a RRC message.

In one embodiment, the RRC message could be a reconfiguration message. The RRC message could be a release message.

In one embodiment, the first configuration could be derived from the second configuration. The first configuration could be derived from the second configuration and a transmission occasion of a SSB. The first configuration could be derived from the second configuration and a periodicity of a SSB. The first configuration could be derived from the second configuration and a mask or a ratio.

In one embodiment, PRACH(s) and/or preamble(s) available for the first random access procedure could be a subset of PRACH(s) and/or preamble(s) available for the second random access procedure. The first configuration could indicate PRACH and/or preamble which is a subset of or a part of PRACH and/or preamble indicated by the second configuration.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a first random access procedure to request a first system information on a cell based on a first configuration, and (ii) to initiate a second random access procedure for a purpose other than request the first system information based on a second configuration. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
the UE receives a first Physical Random Access Channel (PRACH) configuration wherein the first PRACH configuration is indicated by a System Information Block (SIB) different from SIB 1 wherein the SIB different from SIB 1 is provided by a second cell; and
the UE initiates a first random access procedure to request SIB1 on a first cell based on the first PRACH configuration.

2. The method of claim 1, wherein the UE receives a second PRACH configuration via SIB1.

3. The method of claim 2, wherein the UE initiates a second random access procedure for a purpose other than requesting SIB1 based on the second PRACH configuration.

4. The method of claim 2, wherein the UE initiates a second random access procedure for Radio Resource Control (RRC) connection establishment based on the second PRACH configuration.

5. The method of claim 2, wherein the UE initiates a second random access procedure for requesting a system information different from SIB1 based on the second PRACH configuration.

6. A method for a User Equipment (UE), comprising:
the UE receives a first Physical Random Access Channel (PRACH) configuration wherein the first PRACH configuration is indicated by a System Information Block (SIB) different from SIB1 wherein the SIB different from SIB1 is provided by a first cell; and
the UE initiates a first random access procedure to request SIB1 on the first cell based on the first PRACH configuration.

7. The method of claim 6, wherein the UE receives a second PRACH configuration via SIB1.

8. The method of claim 7, wherein the UE initiates a second random access procedure for a purpose other than requesting SIB1 based on the second PRACH configuration.

9. The method of claim 7, wherein the UE initiates a second random access procedure for Radio Resource Control (RRC) connection establishment based on the second PRACH configuration.

10. The method of claim 7, wherein the UE initiates a second random access procedure for requesting a system information different from SIB1 based on the second PRACH configuration.

11. A method for a User Equipment (UE), comprising:
the UE receives a first Physical Random Access Channel (PRACH) configuration wherein the first PRACH configuration is one or more of predefined, preconfigured, indicated by Physical Broadcast Channel (PBCH) or Master Information Block (MIB), and indicated by a Radio Resource Control (RRC) release message; and
the UE initiates a first random access procedure to request SIB 1 on a first cell based on the first PRACH configuration.

12. The method of claim 11, wherein the UE receives a second PRACH configuration via SIB1.

13. The method of claim 12, wherein the UE initiates a second random access procedure for a purpose other than requesting SIB1 based on the second PRACH configuration.

14. The method of claim 12, wherein the UE initiates a second random access procedure for RRC connection establishment based on the second PRACH configuration.

15. The method of claim 12, wherein the UE initiates a second random access procedure for requesting a system information different from SIB1 based on the second PRACH configuration.
